(19) United States
(12) Patent Application Publication
(10) Pub. No.: US 2012/0268777 A1
(43) Pub. Date: Oct. 25, 2012

(54) SYSTEMS AND METHODS FOR DRIVERLESS, PEER-TO-PEER MOBILE PRINTING

(75) Inventor: Gary P. Fry, Berkshire (GB)

(73) Assignee: Global Graphics Software Limited, Cambourne (GB)

(21) Appl. No.: 13/357,005

(22) Filed: Jan. 24, 2012

Related U.S. Application Data
(60) Provisional application No. 61/435,642, filed on Jan. 24, 2011.

(51) Int. Cl. G06K 15/02

(52) U.S. Cl. 358/1.15

(57) ABSTRACT

A method of printing a document from a mobile device includes providing a document in a native format. For example, the native format is selected from a word processing format, a slide presentation format, a spreadsheet format, a computer-aided design format, a Portable

Document Format, or a XPS format. The method further includes delivering the document in the native format from the mobile device to a printer; rendering the document within the printer from the native format; and printing the rendered document onto a medium using the printer.

### CROSS-REFERENCE TO RELATED APPLICATIONS

This application claims the benefit under 35 U.S.C. §119(e) of U.S. Provisional Patent Application Ser. No. 61/435,642 filed on Jan. 24, 2011, which is incorporated herein by reference.

### BACKGROUND

A “mobile device” is defined herein to be any computing platform that is routinely carried by a user and can include, for example, cellular telephones, smart phones, and PDAs (personal digital assistants), especially (but not limited to) those capable of receiving emails or accessing the internet; digital still picture cameras; personal media players, especially those capable of storing and displaying still images and documents; laptop, notebook, netbook, and tablet computers; and ‘slate’ computers, such as the Apple iPOD™. It is often desirable to have the capability to print from the mobile device at multiple locations and using different printers.

A particular difficulty with printing from many mobile devices is that the operating systems used on many of these devices don't include a printing subsystem. The operating systems on many laptops, tablets and some slates do include a printing subsystem, but the operating systems on most smaller devices such as cell phones and even smart phones, do not. The absence of a print subsystem means that it's hard for a user to print everything that he wants to print at a variety of different locations where different brands or models of printer may be installed.

Even when the operating system used in a mobile device includes a print subsystem, it can be difficult for a mobile user to send documents to a variety of different printers at different sites because often a different printer driver must be discovered and installed for each type of printer. This applies, in particular, to laptops, tablets and some slates which include a print subsystem.

Furthermore, even if there is a print subsystem available only the more powerful mobile devices in current use have a fast enough processor and enough storage space to make high-quality conversions of a variety of printable documents into a suitable page description language (PDL) for the printer connected to the device. PDLs in common usage include, but are not limited to, Adobe System's PostScript™, numerous flavors of Hewlett Packard Company's Printer Control language (PCL) the XML Paper specification (XPS), Epson's Esc/P and Esc/Page, the Portable Document Format (PDF) defined in ISO 32000-1:2010 and others.

There are a large number of PDLs. Moreover, implementations of the nominally same PDL can be sufficiently different across printers from different (or even the same) vendor. To complicate matters further, some printers require the use of a job control language such as Hewlett Packard Company's Printer Job Language (PJL), or use printer-specific PostScript code fragments from a PostScript Printer Description (PPD) file or the like, to provide configuration instructions to the printer. This means that knowledge about the specific printer being targeted may be required to convert a document for printing in order to guarantee that the output will be correct, that the text will be legible, or even that any output will be produced at all. This would normally be the job of the printer driver under a desktop or laptop operating system such as Windows™ or Mac™ OS.

There are a number of conventional arrangements for directing printing of a document from a mobile device, particularly those devices that do not include a print subsystem. In at least some conventional arrangements, the document to be printed is not converted to a PDL on the mobile device itself, but is transmitted as-is instead to some other platform that has more computing power, more storage capacity, and (in at least some cases) is running an operating system that includes a print subsystem and therefore allows the use of off-the-shelf printer drivers.

For example, the document can be transmitted into the cloud (for example, either locally on an organization's intranet or to a global server on the extranet), converted there and forwarded to a printer. In some arrangements, the printer may poll the cloud to discover if new jobs are waiting for it in order to avoid issues with firewalls, but the appearance to the user is that the cloud has forwarded the job to the printer.

Cloud printing solutions can suffer from a number of potential disadvantages, including slow printing (or printing with unpredictable speeds) and security concerns as documents are transmitted outside of an organization's firewall.

In other conventional arrangements, the document is transmitted as-is directly to the printer, and the printer is responsible for identifying a suitable conversion server. The use of a document conversion server that is separate from the printer may complicate the installation of a printer, and reduce the value of such a solution in environments such as homes and small offices where the provision of an additional server on-premise could be overly expensive.

A third class of conventional mobile print arrangements includes transmitting a document from the mobile device to a computer running on the local network, where the document is converted into a suitable PDL for the printer using a locally-installed printer driver, and then transmitted onwards to the printer. These solutions may enable printing from mobile devices to low-cost and legacy printers, but require that both the printer and the PC are running in order to print documents, leading to relatively high energy use.

In yet other conventional arrangements, the document is converted from the native document format to PDL on the mobile device itself and then transmitted directly to the printer. The constraints of the relatively low CPU power and memory availability of many mobile devices, combined with a lack of specific data about the printer being used, mean that these arrangements can often only provide relatively simplistic renderings of the document, which may not meet the quality criteria of a buyer or user. The high load on the mobile device's processor can also impact battery life of the mobile device adversely.

### BRIEF SUMMARY

One embodiment is a method of printing a document from a mobile device. The method includes providing a document in a native format. For example, the native format is selected from a word processing format, a slide presentation format, a spreadsheet format, a computer-aided design format, a Portable Document Format, or a XPS format. The method further includes delivering the document in the native format from the mobile device to a printer; rendering the document within the printer from the native format; and printing the rendered document onto a medium using the printer. Other possible native formats may include an e-mail or web page format (e.g., plain text, rich text, HTML (with or without a style definition format such as CSS or scripting instructions in a format such as JavaScript); or a raster image format (e.g. Joint Photographic Experts Group (JPEG), Tagged Image File Format (TIFF), etc.).

Another embodiment is a computer readable storage medium having processor-executable instructions. The processor-executable instructions when installed onto a system enable the system to perform actions including receiving a document in the native format from a mobile device by a printer; rendering the document within the printer from the native format; and printing the rendered document onto a medium using the printer. The native format can be, for example, a word processing format, a slide presentation format, a spreadsheet format, a computer-aided design format, a Portable Document Format, or a XPS format. Other possible native formats may include an e-mail or web page format (e.g., plain text, rich text, HTML (with or without a style definition format such as CSS or scripting instructions in a format such as JavaScript); or a raster image format (e.g. Joint Photographic Experts Group (JPEG), Tagged Image File Format (TIFF), etc.).

Yet another embodiment is a printer comprising a receiving component configured and arranged to receive a document in a native format from a mobile device; a renderer configured and arranged to render the document from its native format; and a marking engine configured and arranged to print the rendered document onto a medium. The native format can be, for example, a word processing format, a slide presentation format, a spreadsheet format, a computer-aided design format, a Portable Document Format, or a XPS format. Other possible native formats may include an e-mail or web page format (e.g., plain text, rich text, HTML (with or without a style definition format such as CSS or scripting instructions in a format such as JavaScript); or a raster image format (e.g. Joint Photographic Experts Group (JPEG), Tagged Image File Format (TIFF), etc.).

A further embodiment is a system that comprises the printer described above and a mobile device. Optionally, the mobile device does not include printer subsystem or a print driver for the printer.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic block diagram of one embodiment of a printer and mobile device, according to the invention; and

FIG. 3 is a schematic representation of another embodiment of a printer and mobile device, according to the invention.

### DETAILED DESCRIPTION

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of printer that includes a processor. Suitable printers typically include mass memory and typically include methods for communication with other devices including mobile devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a printer.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

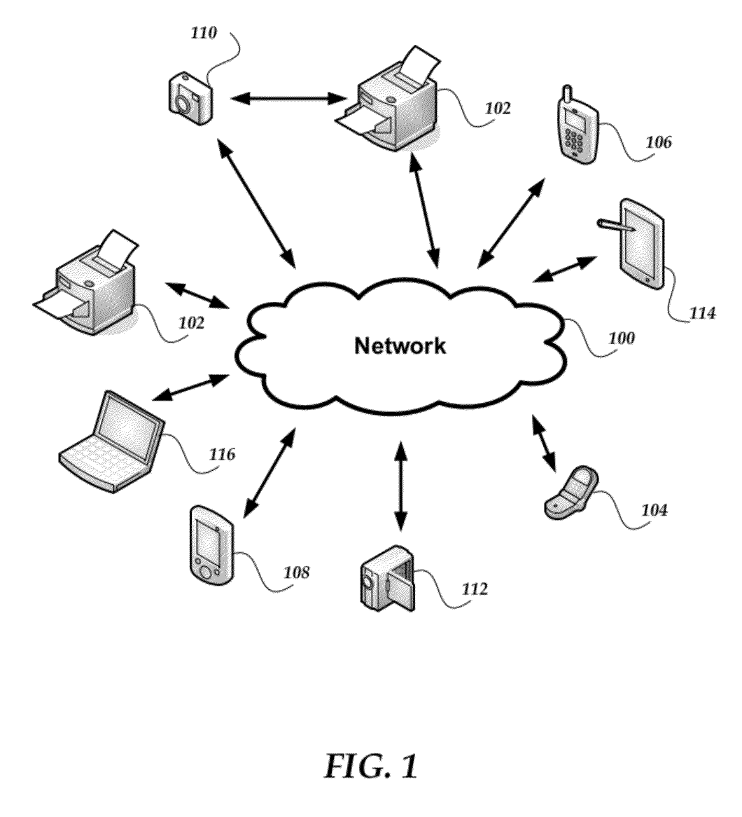

FIG. 1 illustrates one embodiment of an environment for the invention. In FIG. 1, a network environment is illustrated, but it will be understood that the invention is also applicable to unnetworked devices (e.g., printers) as well. It will be understood that the network environment can be a local area network, a wide area network, or any combination thereof. It will also be understood that the network can include devices, other than those illustrated, coupled to the network and that there may be multiple devices of each type illustrated connected to the network.

The illustrated environment of FIG. 1 includes a network 100 to which is attached, either directly or through other devices, one or more printers 102 and one or more mobile devices which may include, for example, cell phones 104, smart phones 106, personal data assistants (PDA's) 108, cameras 110, video cameras 112, tablet or slate computers 114, and laptop computers 116. Other devices can optionally be attached to the network such as computers, portable storage devices (e.g., compact discs, DVDs, memory sticks, flash drives, or other optical or magnetic storage media), and the like. Any of these devices can be connected directly to the network or via another device. A mobile device (e.g., camera 110) can optionally be connected directly to a printer 102 through a wired or wireless connection or by transferring documents from the mobile device to the printer using a portable storage device (e.g., a compact disk, DVD, memory stick, flash drive, or other optical or magnetic storage media). It will be understood that the printers and the methods for printing documents describe herein may also be used with devices other than mobile devices.

In at least some embodiments, the mobile device does not include a print subsystem (e.g., a subsystem that uses print drivers to convert a document into a page description language for consumption by a printer.) In some embodiments, the mobile device may include a print subsystem but does not include a print driver for a particular printer to be used. In some embodiments, the mobile device may include a print subsystem but the device or user chooses not to use that print subsystem to convert the document into a page description language. This may be the case where such conversion may exceed the processing capability of memory of the device or the user or device may request that the document not be converted and, instead, sent to the printer in its native format.

In at least some embodiments, to print a document from the mobile device, the user of a mobile device selects an available printer using the user interface on the mobile device itself. Alternatively, the user may request that the document be printed and the mobile device selects the printer for printing the document.

The list of available printers may be provided to the mobile device in any manner. For example, the mobile device may query a network to which the device is attached for available printers. Alternatively or additionally, printers may advertise their availability to the mobile device. In at least one embodiment, the mobile device identifies accessible printers that may be connected to automatically and allows the user to choose from the list presented. In some embodiments, additional metadata about each printer can be provided. Examples of metadata include the maximum paper size, available paper types, whether the printer can print in color, whether the printer supports duplex, the physical location of the printer, and the like.

Alternatively, the document may be placed on a portable storage medium, or the mobile device may be connected directly to a printer, and the document provided to the printer through the portable storage medium or direct connection with the printer. Transfer of the document to the printer or the portable storage device may be effectuated through the user interface of the mobile device.

In some embodiments, the mobile device interface may allow the user to set configuration items beyond those specified by the document itself Such configuration items may include, for example, whether to print single or double-sided, the number of printed copies, and the like. Metadata associated with the document may include information such as, for example, paper size, font type and size, margins, and the like. Optionally, the mobile device interface may allow the user to set or change these parameters.

The original document to be printed is transmitted to the printer using any suitable wireless or wired communication methods. Such methods include, but are not limited to, wireless communication methods such as Bluetooth or TCP/IP over a wifi connection corresponding to one of the 802.11 standards, near-field communication; wired communications such as communication over a USB cable, or portable media storage, such as a memory card (such as a SD card (from a camera, for instance), a micro-SD card (from a smart-phone, for instance), or a USB thumb drive (from a laptop, netbook, notebook or tablet, for instance)) that can be removed from the mobile device and attached to the printer.

The document is transmitted as-is in the native format. Any suitable native format can be used, including, but not limited to a) a fixed format intended for sharing of documents (e.g. the Portable Document Format (PDF, ISO 32000-1:2010), or Microsoft's XML Paper Specification (XPS)); b) a word processing format (e.g. the .doc or .docx formats created by Microsoft Office Word, the Open Document Text Format (.odt) created by OpenOffice Writer, the Rich text Format (RTF), and the like); c) a slide presentation format (e.g. the .ppt or .pptx formats created by Microsoft Office PowerPoint, the .odp format created by OpenOffice Presentation, and the like); d) a spreadsheet format (e.g. the .xls or .xlsx formats created by Microsoft Office Excel, or the Open Office spreadsheet format (.ods) created by OpenOffice Calc, and the like); e) a computer-aided design (CAD) format (such as format used by AutoDesk's AutoCAD program); f) an e-mail or web page format (e.g., plain text, rich text, HTML (with or without a style definition format such as CSS or scripting instructions in a format such as JavaScript); or g) a raster image format (e.g. Joint Photographic Experts Group (JPEG), Tagged Image File Format (TIFF), etc.). It will be recognized that other formats may be included in this listing, particularly formats generated for specialist applications such as applications utilized by engineers, architects, and the like.

The printer processes the supplied document to render it for printing on a medium (e.g., paper, plastic, metal, or any other suitable medium). Any type of printer may be used including those that print using toner, inkjet, or any other printing technology.

In some embodiments, the printer may transmit error and progress information back to the mobile device. In at least some of these embodiments, the transmitted information may provide immediate feedback as to any problems encountered in processing or a message that the document has completed printing.

In order to process the documents received from the mobile device, the printer must be capable of accepting and processing document formats that are generally not currently submitted to printers. Modern printers commonly accept all or a subset of the PDLs described above. In addition, some will accept a small number of raster image formats, most commonly JPEG. Printers are generally not configured to process documents in the wider variety of formats listed above.

In conventional systems, when a word-processing format such as Microsoft Word is printed, it is opened in an application such as Microsoft Word or Open Office on a computer workstation. The user then requests the application to print the document. The application communicates the presence, position, rotation, size, color etc. of every graphical element on the page to the printer driver installed on that computer (or on a print server through which the job will be printed) and associated with the printer to which the document should be sent. The printer driver on the computer workstation converts the document to an appropriate PDL for that printer. Thus the document in word-processing format is never seen directly by the printer. In contrast, the present invention includes the support, within the printer, of document formats that are designed and intended for document creation, editing and on-screen viewing, such as a word-processing, slide, or spreadsheet format.

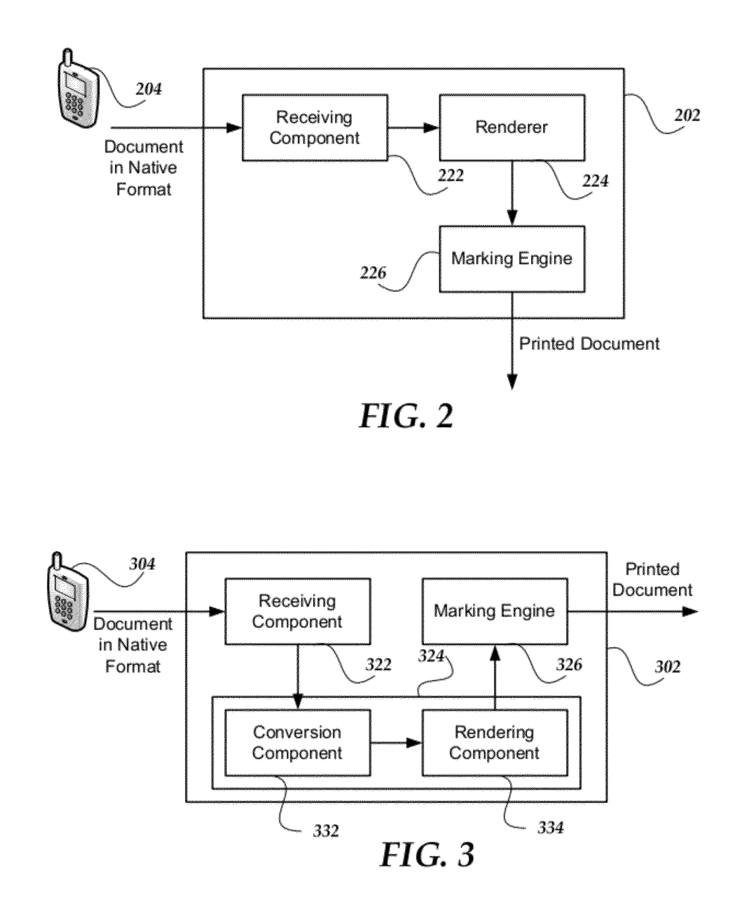

In at least some embodiments, support for processing of documents in their native formats can be provided by extension of the Raster Image Processor (RIP, often referred to as a ‘renderer’) within the printer to directly process these document formats as well as (or even instead of) PDLs such as PostScript, PCL and the like. FIG. 2 illustrates one example of such a printer 202 which is capable of receiving a document from a mobile device 204. The printer 202 includes a receiving component 222, a renderer 224, and a marking engine 226. It will be understood that the printer may include other components as well. The receiving component 222 is capable of receiving the document from the mobile device 204 and may include any suitable arrangement for input of the document including, but not limited to, arrangements for wired or wireless communication or arrangements for receiving documents from portable storage devices.

The renderer 224 processes the document in its native format and generates instructions for printing the document on a medium. Typically, the renderer 224 is capable of processing documents in a specified set of formats. The renderer 224 is optionally capable of being updated to add new formats when desired. In at least some instances, the renderer 224 does not convert the document from the native format to a page description language format, but rather directly renders the document in the native format.

The marking engine 226 receives the instructions from the renderer 224 and prints the document on the medium. Any suitable marking engine can be used.

In other embodiments, support for processing of documents in their native formats is provided by addition of a conversion process within the printer through which any received office document files are passed before being passed on to a renderer in the form of a PDL such as PostScript, or the like. FIG. 3 illustrates one example of such a printer 302 which is capable of receiving a document from a mobile device 304. The printer 302 includes a receiving component 322, a renderer 324, and a marking engine 326. It will be understood that the printer may include other components as well. The receiving component 322 is capable of receiving the document from the mobile device 204 and may include any suitable arrangement for input of the document including, but not limited to, arrangements for wired or wireless communication and arrangements for receiving documents from portable storage devices.

The renderer 324 processes the document in its native format and generates instructions for printing the document on a medium. In the illustrated embodiment, the renderer 324 includes at least two components: a conversion component 332 and a rendering component 334. The conversion component 332 converts the document from the native format to a page description language format or the like. The rendering component 334 then processes the converted document in the page description language format and renders it into instructions for the marking engine 326.

The conversion by the conversion component 332 may be performed for the entire document before providing the document to the rendering component 334 or may be performed piecewise. In the latter instance, the rendering component 334 may optionally render pieces of the document that have been converted while other pieces are being processed by the conversion component 332.

Typically, the conversion component 332 is capable of processing documents in a specified set of formats. The conversion component 332 is optionally capable of being updated to add new formats when desired.

The marking engine 326 receives the instructions from the renderer 324 and prints the document on the medium. Any suitable marking engine can be used.

In at least some embodiments, no other computing platforms are involved in the transmission and printing other than the mobile device and the printer. Moreover, in at least some embodiments, the mobile device does not require any knowledge of the requirements of the printer in order to ensure that an accurate and legible representation of the document is printed. The mobile device does not require a printer driver for the printer.

The systems and methods described herein may provide benefits. Such benefits may include, but are not limited to, one or more of the following: a) mobile device battery life is not impacted by the processor load required to convert the document on the device; b) print quality is not adversely affected by the need to perform a simplified conversion to a page description language on a relatively low-power mobile device such as a smart phone; c) printing is not delayed by the time taken to transmit the document to a cloud server for conversion to a page description language and for the converted document to be returned to the printer; d) the security risks associated with transferring the document outside of the user's firewall to a conversion server in the cloud are avoided or reduced because the document is delivered directly from mobile device to printer; e) only the mobile device and the printer need to be powered on in order to print, reducing energy consumption; or f) printer installation is simplified by avoiding the need to identify and associate an additional computer or cloud service with the mobile device or printer. Moreover, users of higher-powered mobile devices such as laptops do not need to locate, install and configure a printer driver for every printer to which they wish to send documents.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of printing a document from a mobile device, the method comprising:
providing a document in a native format, wherein the native format is selected from a word processing format, a slide presentation format, a spreadsheet format, a computer-aided design format, a Portable Document Format, or a XPS format;
delivering the document in the native format from the mobile device to a printer;
rendering the document within the printer from the native format; and
printing the rendered document onto a medium using the printer.

2. The method of claim 1, wherein rendering the document comprises rendering the document within the printer using a rendering component of the printer that is configured and arranged to render documents from the native format.

3. The method of claim 1, wherein rendering the document comprising converting the document from the native format to a page description language format using a conversion component with the printer and rendering the document in the page description language format using a rendering component of the printer.

4. The method of claim 1, wherein the native format is a word processing format selected from .doc format, .docx format, .odt format, or .rtf format.

5. The method of claim 1, wherein the native format is a slide presentation format selected from .ppt format, .pptx format, or .odp format.

6. The method of claim 1, wherein the native format is a spreadsheet format selected from .xls format, .xlsx format, or .ods format.

7. The method of claim 1, wherein the native format is a word processing format, a slide presentation format, a computer-aided design format, or a spreadsheet format.

8. A computer readable storage medium having processor-executable instructions, the processor-executable instructions when installed onto a system enable the system to perform actions, comprising:
receiving a document in the native format from a mobile device by a printer, wherein the native format is a word processing format, a slide presentation format, a spreadsheet format, a computer-aided design format, a Portable Document Format, or a XPS format;
rendering the document within the printer from the native format; and
printing the rendered document onto a medium using the printer.

9. The computer readable storage medium of claim 8, wherein rendering the document comprises rendering the document within the printer using a rendering component of the printer that is configured and arranged to render documents from the native format.

10. The computer readable storage medium of claim 8, wherein rendering the document comprising converting the document from the native format to a page description language format using a conversion component with the printer and rendering the document in the page description language format using a rendering component of the printer.

11. A printer, comprising:
a receiving component configured and arranged to receive a document in a native format from a mobile device, wherein the native format is a word processing format, a slide presentation format, a spreadsheet format, a computer-aided design format, a Portable Document Format, or a XPS format;
a renderer configured and arranged to render the document from its native format; and
a marking engine configured and arranged to print the rendered document onto a medium.

12. The printer of claim 11, wherein the renderer comprises a conversion component configured and arranged to convert the document from the native format to a page description language format and a rendering component configured and arranged to render the converted document which is in the page description language format.

13. The printer of claim 11, wherein the renderer is configured and arranged to render the document in the native format without converting the document to a page description language format.

14. The printer of claim 11, wherein the native format is a word processing format selected from .doc format, .docx format, .odt format, or .rtf format.

15. The printer of claim 11, wherein the native format is a slide presentation format selected from .ppt format, .pptx format, or .odp format.

16. The printer of claim 11, wherein the native format is a spreadsheet format selected from .xls format, .xlsx format, or .ods format.

17. The printer of claim 11, wherein the native format is a word processing format, a slide presentation format, a computer-aided design format, or a spreadsheet format.

18. A system for printing a document, the system comprising:
a mobile device configured and arranged to provide a document in a native format, the native format, wherein the native format is a word processing format, a slide presentation format, a spreadsheet format, a computer-aided design format, a Portable Document Format, or a XPS format; and
a printer configured and arranged to receive the document in the native format from the mobile device, the printer comprising:
a renderer configured and arranged to render the document from its native format, and
a marking engine configured and arranged to print the rendered document onto a medium.

19. The system of claim 18, wherein the mobile device does not include a printer driver for the printer.

20. The system of claim 18, wherein the mobile device is a cell phone, smart phone, personal digital assistant, camera, or video camera.
